(19) United States
(12) Patent Application Publication
(10) Pub. No.: US 2014/0238215 A1
(43) Pub. Date: Aug. 28, 2014

(54) PICK STABILIZATION DEVICE

(71) Applicant: Alta Paterson, Tulalip, WA (US)

(72) Inventor: Alta Paterson, Tulalip, WA (US)

(21) Appl. No.: 13/778,385

(22) Filed: Feb. 27, 2013

(51) Int. Cl. G10D 3/16

(52) U.S. Cl. CPC G10D 3/163
USPC 84/322; 156/60

(57) ABSTRACT

A pick stabilization device for use with a musical instrument pick, the pick stabilization device being formed of a plastic foam tab that is sized to be received on a musical instrument pick, with an adhesive provided on opposing front and a back surfaces of the tab, wherein a first of the front and back surfaces of the tab is a pick interface surface thereof, and a second of the front and back surfaces of the tab is a user interface surface thereof; and packaging including: a carrier sheet having a non-stick surface having the pick interface surface removably adhered thereto, and a protective backing material having a non-stick surface removably adhered to the user interface surface of the tab.

### FIELD OF THE INVENTION

The present invention relates generally to stabilization devices for musical instrument picks, and in particular to stabilization devices for guitar and mandolin picks.

### BACKGROUND OF THE INVENTION

Picks are generally well-known for producing a brighter sound and different tones than when a musician uses only fingers to play a stringed instrument, such as a guitar or mandolin.

However, instrument picks are limited in their ability to effectively improve grip while playing the instrument.

### SUMMARY OF THE INVENTION

The present invention is a stabilization device for musical instrument picks, and in particular a stabilization device for guitar and mandolin picks. The pick stabilization device of the invention effectively improves the musician's grip on the pick.

According to one aspect of the invention, the pick stabilization device is a tab formed of a thin foam plastic foam material, such as polyethylene terephthalate (PET) plastic or the like, on the order of about 0.5 mm thickness. An adhesive is provided on the broad front and back surfaces of the tab, whereby the tab may be adhesively attached to a guitar or mandolin pick. Once adhered, the pick stabilization device provides adhesive on the exposed surface that improves the musician's grip on the pick.

The adhesive, such as a PSA (pressure sensitive adhesive) or similar adhesive, is provided on both sides of the plastic foam tab. One or more of the plastic foam tabs are emplaced on a carrier sheet of non-stick plastic or paper with a waxed or other non-stick surface, with the adhesive on one pick interface surface being removably adhered to the non-stick surface of the carrier sheet. The non-stick carrier sheet protects the adhesive on the pick interface surface from soiling prior to installing the pick stabilization device on the pick.

A plastic tape or other disposable protective backing material is layered over the adhesive on the second user interface surface of the plastic foam tabs opposite from the pick interface surface to protect it from soiling prior to use, and to adhere the plastic foam tabs to the packaging or another object than the pick.

Prior to installation, the thin plastic foam pick stabilization device, which has the PSA or similar adhesive on both sides, is peeled off of the non-stick carrier sheet, similarly to a label or sticker, whereby adhesive is exposed on the pick interface surface of the pick stabilization device. The pick stabilization device is installed on the pick by pressing the pick interface surface of the plastic foam tab against the pick surface, whereby the on-board adhesive effectively adheres the foam tab to the pick surface.

During installation, the plastic foam tab is wrapped over the ‘gripping’ portion of the pick opposite from an operational tip. Starting in the approximate middle of the foam tab, the pick stabilization device is folded and pressed down over the ‘gripping’ portion of the pick. Accordingly, the foam tab is adhered to both sides of the pick opposite from its operational tip.

The disposable backing material protecting the second user interface surface is optionally formed with a tab that aids in its removal, for example immediately prior to use. The disposable backing material is removed, and the adhesive on the user interface surface of the plastic foam tab is exposed. The pick stabilization device is then ready for operation. The adhesive on the user interface surface of the plastic foam tab permits the user to hold with the pick without it turning between the user's fingers, and without the user dropping the pick. Alternatively, the plastic foam tab is optionally emplaced horizontally on only one side of the ‘gripping’ portion of the pick opposite from its operational tip. Accordingly, in operation the pick stabilization device adheres to only one of the musician's fingers, which leaves the finger holding the other side of the pick free to move.

Specific size dimensions, shape and material of the plastic foam tab are not limitations of the pick stabilization device. Rather, other suitable size dimensions, shapes and materials are also contemplated and may be substituted without deviating from the scope and intent of the present invention to provide a suitable pick stabilization device that is useful in substantially the same way to accomplish substantially the same effect.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a pictorial view showing an example of the pick stabilization device of the invention;

FIG. 2 is a pictorial view showing an example of the pick stabilization device of the invention as installed on a guitar or mandolin pick;

FIG. 3 is a pictorial view showing an example of the pick stabilization device of the invention emplaced on a carrier sheet of non-stick plastic or paper with a waxed or other non-stick surface;

FIG. 4 is a pictorial view showing an example of the pick stabilization device of the invention being adhesively attached to a guitar or mandolin pick;

FIG. 5 is a pictorial view showing an example of the pick stabilization device of the invention having a plastic tape or other disposable protective backing material removed after being adhesively attached to a guitar or mandolin pick; and

FIG. 6 is a pictorial view showing an example of the pick stabilization device of the invention as installed on a single side of the guitar or mandolin pick.

### DETAILED DESCRIPTION OF PREFERRED EMBODIMENT

In the Figures, like numerals indicate like elements.

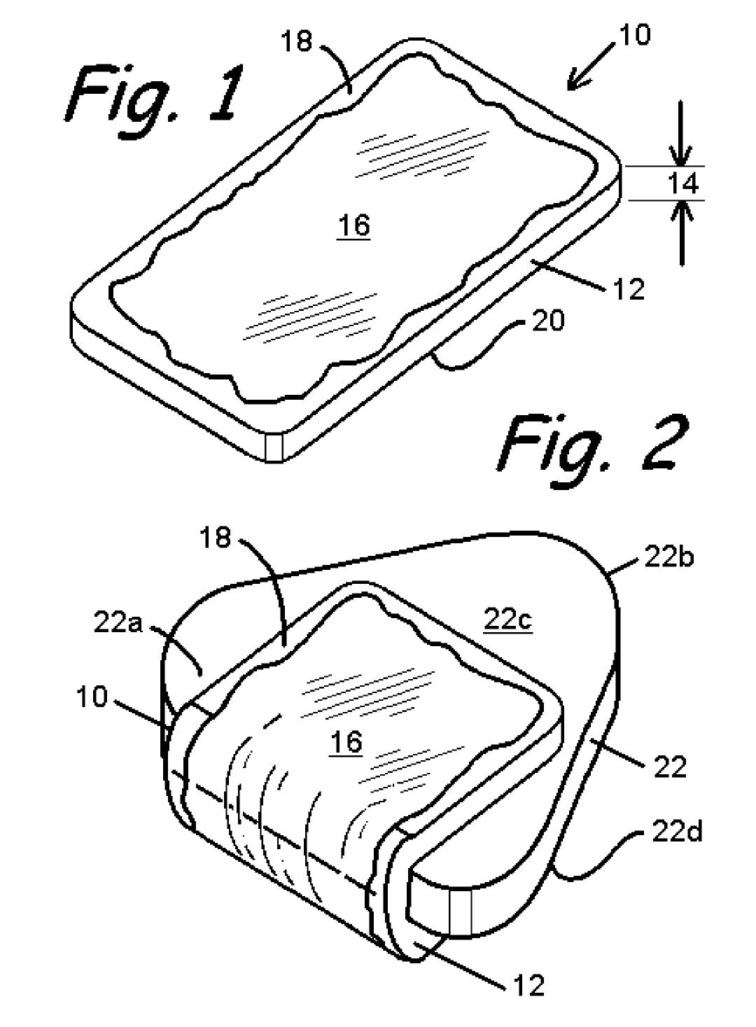

FIG. 1 illustrates an example of a pick stabilization device 10 of the invention, effectively improves a musician's grip on picks for musical instrument, and in particular improves the musician's grip on a guitar and mandolin pick.

Pick stabilization device 10 is a tab 12 formed of a thin foam plastic foam material, such as polyethylene terephthalate (PET) plastic or the like, for example, having a thickness 14 on the order of about 0.5 mm. An adhesive 16 is provided on both the broad front and back surfaces 18, 20 of tab 12, whereby tab 12 may be adhesively attached to a guitar or mandolin pick 22. Once adhered, pick stabilization device 10 provides adhesive 16 on the exposed surface 18 or 20 that improves the musician's grip on pick 22. Adhesive 16, such as a pressure sensitive adhesive (PSA) or similar adhesive, is provided on both sides 18, 20 of plastic foam tab 12.

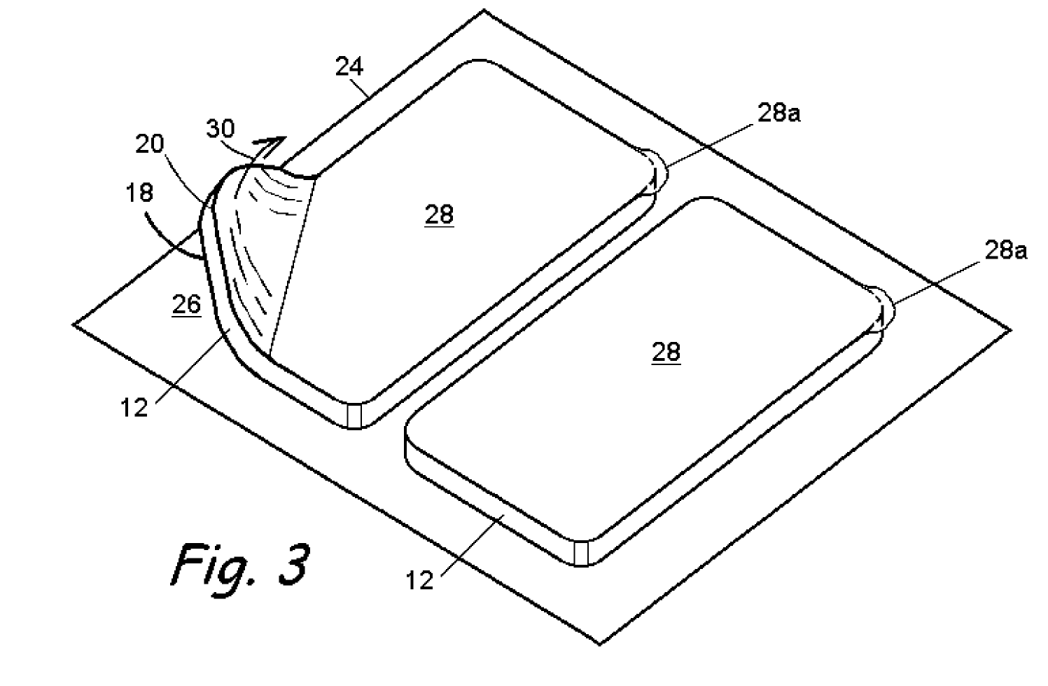

FIG. 2 illustrates pick stabilization device 10 as installed on guitar or mandolin pick 22 and ready for use.

FIG. 3 illustrates sample packaging of pick stabilization device 10. Here, one or more plastic foam tabs 12 (two shown) of pick stabilization device 10 are emplaced on a carrier sheet 24 of non-stick plastic or paper with a waxed or other non-stick surface 26, with adhesive 16 on one pick interface surface 18 being removably adhered to non-stick surface 26 of carrier sheet 24. Non-stick carrier sheet 24 protects adhesive 16 on pick interface surface 18 from soiling prior to installing of pick stabilization device 10 on pick 22.

When adhesive 16 is provided on second user interface surface 20 of plastic foam tabs 12 opposite from pick interface surface 18, a disposable non-stick protective backing material 28, such as a plastic tape or other disposable non-stick material, is optionally layered over adhesive 16 on second user interface surface 20 to protect it from soiling prior to use, and to adhere plastic foam tabs 12 to the packaging or another object than pick 22, e.g., the user's finger.

Prior to installation, thin plastic foam pick stabilization device 10, which has PSA or similar adhesive 16 on one or both sides 18, 20, including protective backing material 28 if present, is peeled off (arrow 30) of non-stick surface 26 of carrier sheet 24, similarly to a label or sticker, whereby adhesive 16 is exposed on pick interface surface 18 of plastic foam tab 12 of pick stabilization device 10.

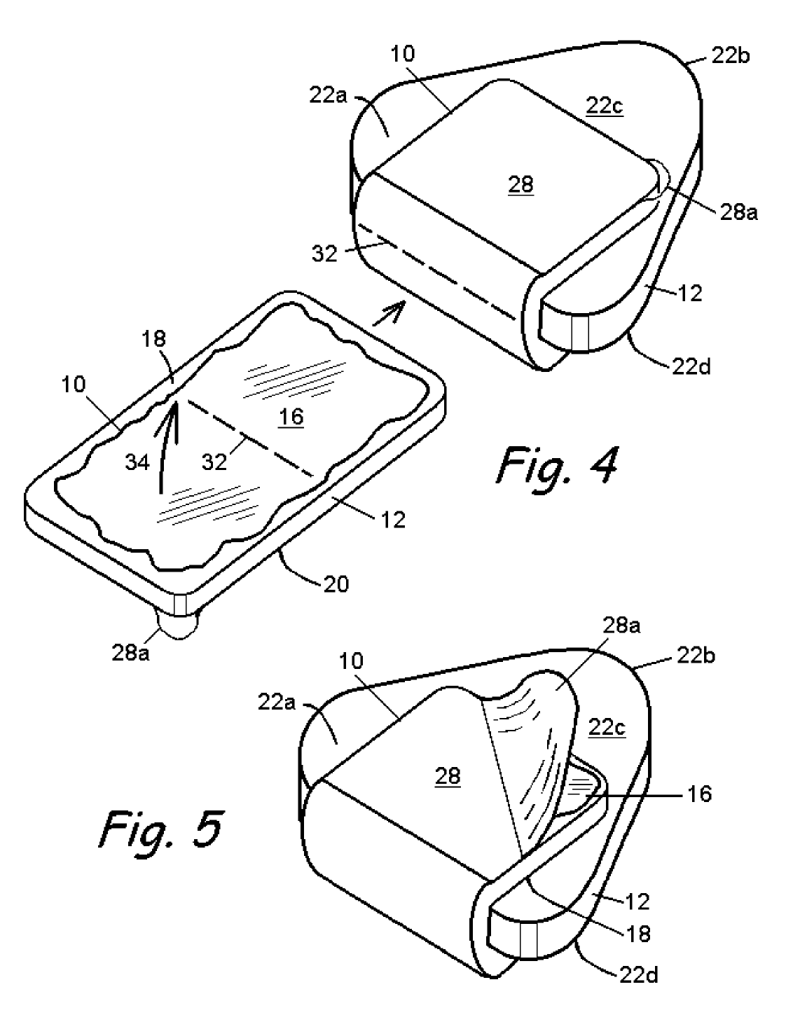

As illustrated in FIG. 4, during installation, the plastic foam tab is optionally wrapped over a wide ‘gripping’ portion 22a of pick 22 opposite from a blunt operational tip 22b thereof.

Starting in an approximate middle 32 of foam tab 12, pick stabilization device 10 is folded (arrow 34) and pressed down over ‘gripping’ portion 22a of pick 22, whereby adhesive 16 adheres pick interface surface 18 of foam tab 12 to pick 22. Accordingly, foam tab 12 is attached to both sides 22c, 22d of ‘gripping’ portion 22a of pick 22 opposite from its operational tip 22b.

As illustrated in FIG. 5, after both sides 18, 20 of plastic foam tab 12 are adhesively attached to ‘gripping’ portion 22a of both sides 22c, 22d of pick 22, disposable backing material 28 protecting adhesive 16 on exposed second user interface surface 20 is removed, for example immediately prior to use. Optionally, disposable backing material 28 is formed with a tab 28a that aids in its removal. Disposable backing material 28 is removed from second user interface surface 20, and adhesive 16 on user interface surface 20 of plastic foam tab 12 is exposed. Pick stabilization device 10 is then ready for operation, as illustrated in FIG. 2.

Adhesive 16 on exposed user interface surface 20 of plastic foam tab 12 permits the user to retain pick 22 without it turning between the user's fingers, and without the user dropping pick 22.

Specific size dimensions, shape and material of plastic foam tab 12 are not limitations of pick stabilization device 10. Rather, other suitable size dimensions, shapes and materials are also contemplated and may be substituted without deviating from the scope and intent of the present invention to provide a suitable pick stabilization device 10 that is useful in substantially the same way to accomplish substantially the same effect.

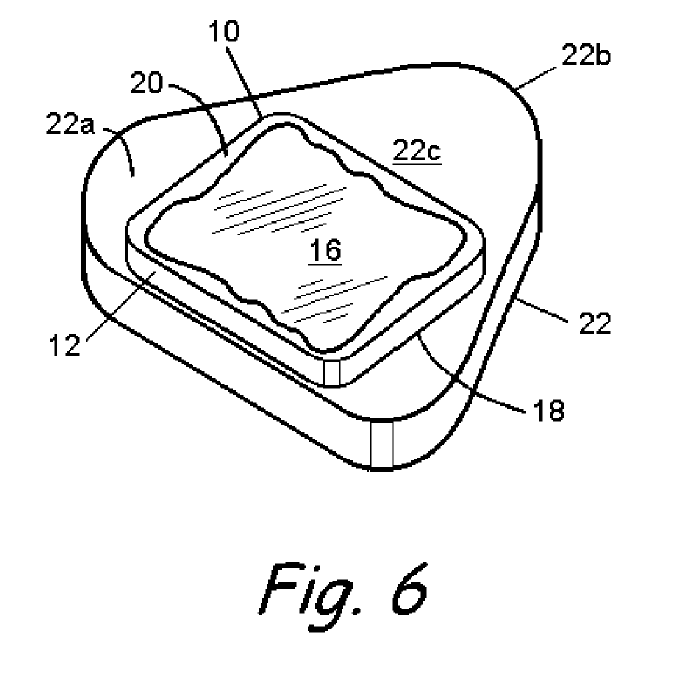

For example, FIG. 6 illustrates pick stabilization device 10 optionally installed on a single side of guitar or mandolin pick 22. During installation, plastic foam tab 12 is emplaced horizontally on only one side 22c (shown) or side 22d of pick 22 and pressed down over ‘gripping’ portion 22a thereof opposite from its operational tip 22b, whereby adhesive 16 adheres pick interface surface 18 of foam tab 12 to pick 22. Thereafter, disposable backing material 28 is removed from second user interface surface 20, and adhesive 16 on user interface surface 20 of plastic foam tab 12 is exposed, as disclosed herein. Accordingly, pick stabilization device 10 is present on only one side 22c (shown) or side 22d of pick 22 and adheres to only one of the musician's fingers, which leaves the other finger holding pick 22 free to move.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A pick stabilization device for use with a musical instrument pick, the pick stabilization device comprising:
a tab sized to be received on a musical instrument pick;
an adhesive is provided on each of a front and a back surface of the tab; and
means for protecting the adhesive from contamination prior to being received on the pick.

2. The pick stabilization device of claim 1, wherein the tab further comprises a plastic foam material.

3. The pick stabilization device of claim 2, wherein the plastic foam material further comprises a polyethylene terephthalate material.

4. The pick stabilization device of claim 2, wherein the adhesive further comprises a pressure sensitive adhesive.

5. The pick stabilization device of claim 2, wherein the means for protecting the adhesive further comprises at least one of: a non-stick plastic sheet, and paper having a non-stick surface.

6. The pick stabilization device of claim 5, further comprising a means for protecting the adhesive from contamination prior to operation by a user.

7. The pick stabilization device of claim 2, wherein the means for protecting the adhesive further comprises packaging means comprising a carrier sheet comprising a non-stick surface having a first of the front and back surfaces of the tab adhesively secured thereto, and a protective backing material comprising a non-stick surface having a second of the front and back surfaces of the tab adhesively secured thereto.

8. The pick stabilization device of claim 2, wherein the tab is further sized to be received on a single side of a musical instrument pick.

9. The pick stabilization device of claim 2, wherein the tab is further sized to be received on two opposing sides of a musical instrument pick, the tab being wrapped over a wide ‘gripping’ portion of the pick opposite from a blunt operational tip thereof.

10. The pick stabilization device of claim 2, further comprising a stringed instrument pick, and wherein the tab is further received on at least one side of the pick and adhesively secured thereto.

11. A pick stabilization device for use with a musical instrument pick, the pick stabilization device comprising:
a plastic foam tab sized to be received on a musical instrument pick;
an adhesive is provided on opposing front and a back surfaces of the tab, wherein a first of the front and back surfaces of the tab further comprises a pick interface surface thereof, and a second of the front and back surfaces of the tab further comprises a user interface surface thereof; and
packaging comprising: a carrier sheet comprising a non-stick surface having the pick interface surface removably adhered thereto, and a protective backing material comprising a non-stick surface removably adhered to the user interface surface of the tab.

12. The pick stabilization device of claim 11, wherein the plastic foam tab further comprises a polyethylene terephthalate (PET) plastic material.

13. The pick stabilization device of claim 11, wherein the adhesive further comprises a pressure sensitive adhesive.

14. The pick stabilization device of claim 13, wherein the plastic foam tab sized to be received on both of two opposing sides of the musical instrument pick.

15. A method of modifying a gripping portion of a musical instrument pick for improving a musician's grip thereon, the method comprising:
sizing a plastic tab to be received on a musical instrument pick;
providing an adhesive on each of a pick interface surface and a user interface surface of the plastic tab;
initially protecting the adhesive from contamination prior to being received on the pick;
subsequently exposing the adhesive on the pick interface surface of the plastic tab;
mating the adhesive on the pick interface surface of the plastic tab to a surface of the pick; and
subsequently exposing the adhesive on the user interface surface of the plastic tab.

16. The method of claim 15, wherein sizing a plastic tab further comprises sizing a tab of a plastic foam material.

17. The method of claim 15, wherein providing an adhesive on each of a pick interface surface and a user interface surface of the plastic tab further comprises providing a pressure sensitive adhesive (PSA).

18. The method of claim 15, wherein sizing a plastic tab to be received on a musical instrument pick further comprises sizing the plastic tab to be received on both side surfaces of the pick.

19. The method of claim 18, wherein mating the adhesive on the pick interface surface of the plastic tab to a surface of the pick further comprises: mating the adhesive on a first portion of the pick interface surface of the plastic tab to a first side surface of the pick, wrapping the tab over an end of the pick, and mating the adhesive on a second portion of the pick interface surface of the plastic tab to a second side surface of the pick opposite from the first side surface thereof.

20. The method of claim 15, wherein exposing the adhesive on the pick interface surface of the plastic tab further comprises removing the plastic tab from a non-stick surface of a carrier sheet; and
wherein exposing the adhesive on the user interface surface of the plastic tab further comprises removing a disposable non-stick protective backing material from the adhesive.
